(19) United States
(12) Patent Application Publication
(10) Pub. No.: US 2021/0203271 A1
(43) Pub. Date: Jul. 1, 2021

(54) PHOTOVOLTAIC ROAD SYSTEM AND WIRELESS CHARGING VEHICLE

(71) Applicant: SHENZHEN CHINA STAR OPTOELECTRONICS SEMICONDUCTOR DISPLAY TECHNOLOGY CO.,LTD., Shenzhen, Guangdong (CN)

(72) Inventor: Xiangyang XU, Shenzhen, Guangdong (CN)

(21) Appl. No.: 16/076,423

(22) PCT Filed: Jul. 25, 2018
(86) PCT No.: PCT/CN2018/096956

§ 371 Date: Aug. 8, 2018

(30) Foreign Application Priority Data
Apr. 24, 2018 (CN) 201810371690.X

(51) Int. Cl. H02S 20/21; B60L 53/12; E01F 11/00; H02J 50/80; H02J 50/10; B60L 53/62; H02S 40/38

(52) U.S. Cl. CPC H02S 20/21; B60L 53/12; E01F 11/00; H02J 50/80; H02J 2310/48; B60L 53/62; H02S 40/38; H02J 2300/24; H02J 50/10

(57) ABSTRACT

The present invention proposes a photovoltaic road system and a wireless charging vehicle. Photovoltaic road modules are disposed under a road surface, and electric energy into which solar energy is converted is transferred to a target vehicle by using a transmission coil of the photovoltaic road system and a receiving coil of the wireless charging vehicle, so as to make full use of clean energy, reduce emission of exhaust gas, and implement green driving.

### BACKGROUND

### Technical Field

The present invention relates to the field of electric vehicles, and in particular, to a photovoltaic road system and a wireless charging vehicle.

### Related Art

With the rapid development of the photovoltaic industry, a photovoltaic road concept also emerges as the times require accordingly. In the prior art, a known photovoltaic road has two main characteristics: a solar device is installed on a road surface, no additional area or space is occupied, and the area and the space on the ground surface are extremely effectively used; there is reinforced glass or another special material on the road surface to protect a power generation device such as a solar panel; and power generated by a photovoltaic panel may be used for illumination and road emergency, be used to charge an electric vehicle, and so on.

Additionally, in recent years, a wireless charging technology is increasingly widely applied to electronic products. Compared with a conventional contact-type electric energy transmission technology, a wireless electric energy transmission technology is safer and more convenient because there is no cable connected between a power supply and a load. Wireless electric energy transmission is mainly implemented in the following several manners: an electromagnetic radiation manner, an electromagnetic induction manner, an electromagnetic resonance manner, and an electric field coupling manner.

Currently, in consideration of efficiency and safety, wireless charging is performed in the electromagnetic induction manner and the electromagnetic resonance manner in most wireless electric energy transmission. All wireless charging systems of the electromagnetic induction type and the electromagnetic resonance type transmit electric energy by means of electromagnetic induction between a coil in a transmitter and a coil in a receiver. The present invention proposes a patent about a photovoltaic road system and a wireless charging vehicle mainly based on a wireless charging technology of an electromagnetic induction type.

### SUMMARY

The present invention provides a photovoltaic road system and a wireless charging vehicle, so as to make full use of clean energy and reduce emission of exhaust gas.

To implement the foregoing solution, technical solutions provided in the present invention are as follows:

The present invention provides a photovoltaic road system, where the photovoltaic road system includes photovoltaic road modules, and the photovoltaic road modules are disposed under a road surface;

the photovoltaic road module includes a first photovoltaic road module and a second photovoltaic road module, at least one second photovoltaic road module is included between two neighboring first photovoltaic road modules, the first photovoltaic road module includes a photovoltaic power generation device and at least one transmission coil, and the second photovoltaic road module includes a photovoltaic power generation device;

the transmission coil is disposed on an outer side of the second photovoltaic road module, and the transmission coil is used to charge a target vehicle by using a supplied first current;

the photovoltaic road system further includes display panels, and the display panels are disposed on some of the second photovoltaic road modules, where

the display panel is a transparent display panel, and the display panel is used to provide real-time road condition information, measure a vehicle distance between two neighboring target vehicles, and monitor real-time vehicle speeds of the target vehicles.

According to a preferred embodiment of the present invention, the photovoltaic power generation device includes a cover, a photovoltaic panel, and an isolation layer.

According to a preferred embodiment of the present invention, the isolation layer is a bottom layer of the photovoltaic power generation device;

the photovoltaic panel is formed on the isolation layer; and

the cover is a transparent glass cover, and is formed on the photovoltaic panel.

According to a preferred embodiment of the present invention, the photovoltaic power generation device further includes an energy storage device, and the energy storage device is used to store electric energy generated by the photovoltaic panel.

According to a preferred embodiment of the present invention, the transmission coil is electrically connected to the energy storage device, and the transmission coil is a conducting wire made of a carbon nanotube material.

According to a preferred embodiment of the present invention, the photovoltaic road system further includes a detection system and a control system, the detection system is used to detect power levels of vehicle-mounted batteries of the different target vehicles and transfer a detection result to the control system, and the control system adjusts a current on the transmission coil according to the detection result.

The present invention further proposes a wireless charging vehicle, where the wireless charging vehicle is applied to the foregoing photovoltaic road system.

According to a preferred embodiment of the present invention, the wireless charging vehicle includes a vehicle-mounted wireless charging system used for wireless charging, and the vehicle-mounted wireless charging system includes at least one receiving coil and a direct-current converter; and

the direct-current converter is used to convert an alternating current generated by the receiving coil into a direct current.

The present invention further proposes a photovoltaic road system, where the photovoltaic road system includes photovoltaic road modules;

the photovoltaic road modules are disposed under a road surface, the photovoltaic road module includes a first photovoltaic road module and a second photovoltaic road module, at least one second photovoltaic road module is included between two neighboring first photovoltaic road modules, the first photovoltaic road module includes a photovoltaic power generation device and at least one transmission coil, and the second photovoltaic road module includes a photovoltaic power generation device, where

the transmission coil is disposed on an outer side of the second photovoltaic road module, and the transmission coil is used to charge a target vehicle by using a supplied first current.

According to a preferred embodiment of the present invention, the photovoltaic power generation device includes a cover, a photovoltaic panel, and an isolation layer.

According to a preferred embodiment of the present invention, the isolation layer is a bottom layer of the photovoltaic power generation device;

the photovoltaic panel is formed on the isolation layer; and

the cover is a transparent glass cover, and is formed on the photovoltaic panel.

According to a preferred embodiment of the present invention, the photovoltaic power generation device further includes an energy storage device, and the energy storage device is used to store electric energy generated by the photovoltaic panel.

According to a preferred embodiment of the present invention, the transmission coil is electrically connected to the energy storage device, and the transmission coil is a conducting wire made of a carbon nanotube material.

According to a preferred embodiment of the present invention, the photovoltaic road system further includes a detection system and a control system, the detection system is used to detect power levels of vehicle-mounted batteries of the different target vehicles and transfer a detection result to the control system, and the control system adjusts a current on the transmission coil according to the detection result.

Beneficial effects are as follows: in the present invention, photovoltaic road modules are disposed under a road surface, and electric energy into which solar energy is converted is transferred to a target vehicle by using a transmission coil, so as to make full use of clean energy, reduce emission of exhaust gas, and implement green driving; and disposition of a display panel can transfer real-time information of the road surface to a driver and can reduce a probability of accident occurrence.

### BRIEF DESCRIPTION OF THE. DRAWINGS

To describe the technical solutions in the embodiments or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a top view of a photovoltaic road system according to a preferred embodiment of the present invention;

FIG. 2 is a cross-sectional view of a cross section AA of the photovoltaic road system in FIG. 1;

FIG. 3 is a cross-sectional view of a cross section BB of the photovoltaic road system in FIG. 1;

FIG. 4 is a cross-sectional view of a cross section CC of the photovoltaic road system in FIG. 1; and

FIG. 5 is a structural block diagram of a photovoltaic road system according to the present invention.

### DETAILED DESCRIPTION

The following embodiments are described with reference to the accompanying drawings, and are used to exemplify particular embodiments that the present invention can be used to implement. Direction terms mentioned in the present invention such as “upper”, “lower”, “front”, “rear”, “left”, “right”, “inner”, “outer”, and “side” are only directions with reference to the accompanying drawings. Therefore, the used direction terms are intended to describe and understand the present invention, but are not intended to limit the present invention. In the drawings, units whose structures are the same are indicated by using the same reference numbers.

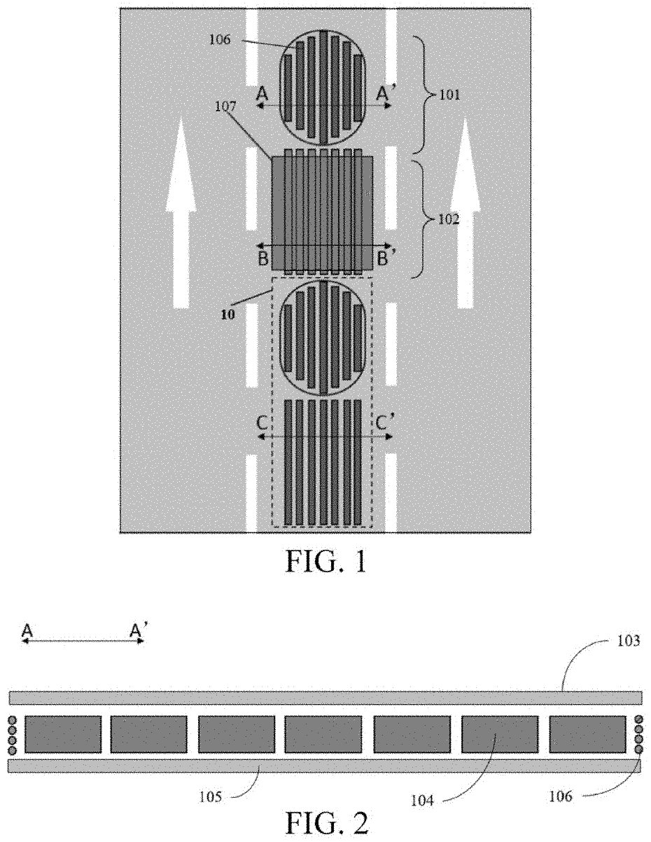

FIG. 1 is a top view of a photovoltaic road system according to a preferred embodiment of the present invention. The photovoltaic road system includes photovoltaic road modules 10.

The photovoltaic road modules 10 are disposed under a road surface, and the photovoltaic road module 10 includes a first photovoltaic road module 101 and a second photovoltaic road module 102. As shown in FIG. 1, at least one second photovoltaic road module 102 is included between two neighboring first photovoltaic road modules 101. In this embodiment, for convenience of introduction, one second photovoltaic road module 102 is included between two neighboring first photovoltaic road modules 101, that is, the first photovoltaic road modules 101 and the second photovoltaic road modules 102 are arranged alternately.

The first photovoltaic road module 101 and the second photovoltaic road module 102 each includes a photovoltaic power generation device, while different from the second photovoltaic road module 102, the first photovoltaic road module 101 further includes a transmission coil. In this embodiment, the transmission coil is disposed on an outer side of the second photovoltaic road module 102, to surround the photovoltaic road module 10, and the transmission coil is used to charge a target vehicle by using a supplied first current.

FIG. 2 is a cross-sectional view of a cross section AA of the first photovoltaic road module 101 in FIG. 1. The photovoltaic power generation device includes a cover 103, a photovoltaic panel 104, and an isolation layer 105. Additionally, a transmission coil 106 located at periphery of the photovoltaic panel is further shown in FIG. 2.

In this embodiment, the isolation layer 105 is a bottom layer of the photovoltaic power generation device, and is mainly used to prevent external water and oxygen from entering the photovoltaic power generation device.

The photovoltaic panel 104 is formed on the isolation layer, and the photovoltaic panel is also referred to as a solar panel, is an assembly formed by assembling several solar cell components on a panel in a particular manner, and is generally used as a unit of a photovoltaic array. A single solar cell cannot be directly used as a power supply, and before being used as a power supply, several single cells need to be connected in series and in parallel and tightly encapsulated into an assembly.

As shown in FIG. 1, in the photovoltaic road module 10, the photovoltaic panel 104 is formed by arranging several photovoltaic cells in parallel, and the photovoltaic cells may be arranged in a transverse or vertical direction.

As shown in FIG. 2, a cover 103 is further disposed on the photovoltaic panel 104, and the cover 103 is a transparent glass cover, so that the photovoltaic panel 104 located under the cover 103 absorbs more solar energy.

In this embodiment, the transmission coil 106 is a conducting wire made of a carbon nanotube material, and the conducting wire may be circular, elliptical, quadrilateral, or the like. Preferably, in this embodiment, the transmission coil 106 is set to be elliptical. Additionally, each first photovoltaic road module 101 may include a plurality of transmission coils 106, and a specific quantity of transmission coils is set according to actual power generation efficiency.

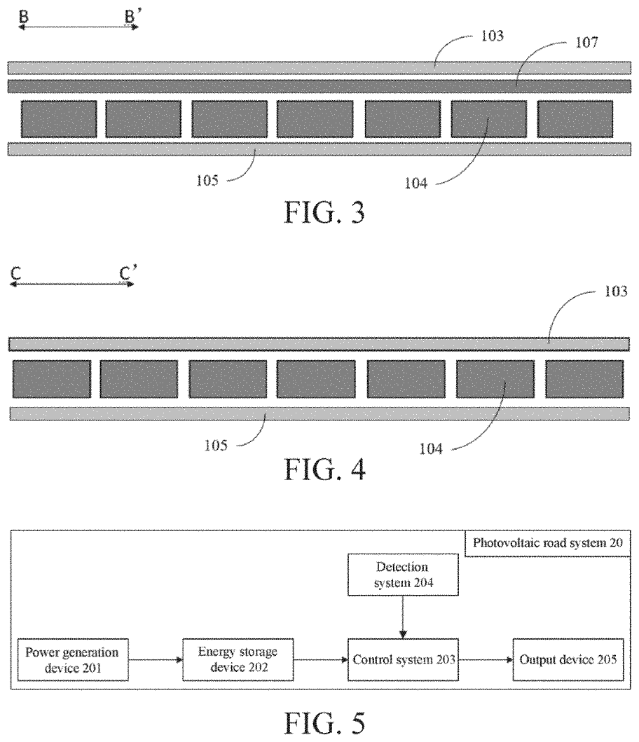

FIG. 3 is a cross-sectional view of a cross section BB of the second photovoltaic road module 102 in FIG. 1. The photovoltaic road modules 10 further include display panels 107, and the display panels 107 are disposed on some of the second photovoltaic road modules 102. Preferably, the display panel 107 is a transparent display panel, and the display panel 107 is used to provide real-time road condition information, measure a vehicle distance between two neighboring target vehicles, and monitor real-time vehicle speeds of the target vehicles, so as to ensure driving safety of a driver, and reduce a probability of accident occurrence. Additionally, the display panel 107 is preferably an AMOLED display panel.

FIG. 4 is a cross-sectional view of a cross section CC of the second photovoltaic road module 102 in FIG. 1. The second photovoltaic road module 102 includes only a power generation device.

The photovoltaic power generation device further includes an energy storage device, and the energy storage device is used to store electric energy generated by the photovoltaic panel 104. Moreover; the energy storage device is further used to supply currents needed by the display panel 107 and the transmission coil 106. Preferably, in this embodiment, the energy storage device is preferably a lithium battery.

FIG. 5 is a structural block diagram of a photovoltaic road system according to the present invention. The photovoltaic road system 20 further includes a control system 203 and a detection system 204. The power generation device 201 (that is, the photovoltaic panel) transmits electric energy generated by absorbing solar energy to the energy storage device 202. The detection system 204 is used to detect power levels of vehicle-mounted batteries of the different target vehicles (the target vehicle includes a receiving coil corresponding to the transmission coil), and transfer a detection result to the control system 203, and the control system 203 adjusts the output device 205 (that is, the transmission coil) according to the detection result.

The present invention proposes a photovoltaic road system mainly based on the wireless charging technology of the electromagnetic induction type. When a first current is supplied to the transmission coil, a magnetic field is generated in the transmission coil of the first photovoltaic road module; and when a target vehicle passes through a region of the magnetic field, the receiving coil cuts a magnetic induction line in the region of the magnetic field, to generate an induction current. According to the first current of the transmission coil and a driving speed of the target vehicle, the receiving coil of the target vehicle generates different induction currents. The induction current generated by the receiving coil of the target vehicle is an alternating current, and the alternating induction current is converted into a stable direct current by using a direct-current converter of a charging system of the target vehicle, to charge a battery of the target vehicle.

The present invention proposes a photovoltaic road system. Photovoltaic road modules are disposed under a road surface, and electric energy into which solar energy is converted is transferred to a target vehicle by using a transmission coil, so as to make full use of clean energy, reduce emission of exhaust gas, and implement green driving; and disposition of a display panel can transfer real-time information of the road surface to a driver and can reduce a probability of accident occurrence.

The present invention further proposes a wireless charging vehicle, where the wireless charging vehicle is applied to the foregoing photovoltaic road system.

The wireless charging vehicle includes a vehicle-mounted wireless charging system used for wireless charging. The vehicle-mounted wireless charging system includes at least one receiving coil and a direct-current converter, where the direct-current converter in the present invention is used to convert an alternating current generated by the receiving coil into a direct current, to charge a battery of the wireless charging vehicle.

The present invention proposes a photovoltaic road system and a wireless charging vehicle. Photovoltaic road modules are disposed under a road surface, and electric energy into which solar energy is converted is transferred to a target vehicle by using a transmission coil of the photovoltaic road system and a receiving coil of the wireless charging vehicle, so as to make full use of clean energy, reduce emission of exhaust gas, and implement green driving; and disposition of a display panel can transfer real-time information of the road surface to a driver and can reduce a probability of accident occurrence.

To sum up, although the present invention is disclosed above with reference to preferred embodiments, the preferred embodiments are not intended to limit the present invention. Any person of ordinary skill in the art may make various variations and modifications without departing from the spirit and scope of the present invention. Therefore, the protection scope of the present invention is subject to the scope defined by the claims.

1. A photovoltaic road system, wherein the photovoltaic road system comprises a plurality of photovoltaic road modules, and the photovoltaic road modules are disposed under a road surface;
the photovoltaic road modules comprise a plurality of first photovoltaic road modules and a plurality of second photovoltaic road modules, at least one second photovoltaic road module is located between two neighboring first photovoltaic road modules, the first photovoltaic road modules comprise a photovoltaic power generation device and at least one transmission coil, and the second photovoltaic road modules comprise a photovoltaic power generation device;
the transmission coil is disposed on an outer side of the second photovoltaic road modules, and the transmission coil is used to charge a target vehicle by supplying a first current;
the photovoltaic road system further comprises display panels, and the display panels are disposed on some of the second photovoltaic road modules, wherein
the display panels are transparent display panels, and the display panels are used to provide real-time road condition information, measure a distance between two neighboring target vehicles, and monitor real-time vehicle speeds of the target vehicles.

2. The photovoltaic road system according to claim 1, wherein the photovoltaic power generation device comprises a cover, a photovoltaic panel, and an isolation layer.

3. The photovoltaic road system according to claim 2, wherein the isolation layer is a bottom layer of the photovoltaic power generation device;
the photovoltaic panel is formed on the isolation layer; and
the cover is a transparent glass cover, and is formed on the photovoltaic panel.

4. The photovoltaic road system according to claim 2, wherein the photovoltaic power generation device further comprises an energy storage device, and the energy storage device is used to store electric energy generated by the photovoltaic panel.

5. The photovoltaic road system according to claim 4, wherein the transmission coil is electrically connected to the energy storage device, and the transmission coil is a conducting wire made of a carbon nanotube material.

6. The photovoltaic road system according to claim 1, wherein the photovoltaic road system further comprises a detection system and a control system, the detection system is used to detect power levels of vehicle-mounted batteries of different target vehicles and transfer a detection result to the control system, and the control system adjusts a current on the transmission coil according to the detection result.

7. A wireless charging vehicle, wherein the wireless charging vehicle is applied to the photovoltaic road system according to claim 1.

8. The wireless charging vehicle according to claim 7, wherein the wireless charging vehicle comprises a vehicle-mounted wireless charging system used for wireless charging, and the vehicle-mounted wireless charging system comprises at least one receiving coil and a direct-current converter; and
the direct-current converter is used to convert an alternating current generated by the receiving coil into a direct current.

9. A photovoltaic road system, wherein the photovoltaic road system comprises a plurality of photovoltaic road modules;
the photovoltaic road modules are disposed under a road surface, the photovoltaic road modules comprise a plurality of first photovoltaic road modules and a plurality of second photovoltaic road modules, at least one of the second photovoltaic road modules is located between two neighboring first photovoltaic road modules, the first photovoltaic road modules comprise a photovoltaic power generation device and at least one transmission coil, and the second photovoltaic road modules comprise a photovoltaic power generation device, wherein
the transmission coil is disposed on an outer side of the second photovoltaic road modules, and the transmission coil is used to charge a target vehicle by supplying a first current.

10. The photovoltaic road system according to claim 9, wherein the photovoltaic power generation device comprises a cover, a photovoltaic panel, and an isolation layer.

11. The photovoltaic road system according to claim 10; wherein the isolation layer is a bottom layer of the photovoltaic power generation device;
the photovoltaic panel is formed on the isolation layer; and
the cover is a transparent glass cover, and is formed on the photovoltaic panel.

12. The photovoltaic road system according to claim 10, wherein the photovoltaic power generation device further comprises an energy storage device, and the energy storage device is used to store electric energy generated by the photovoltaic panel.

13. The photovoltaic road system according to claim 12, wherein the transmission coil is electrically connected to the energy storage device, and the transmission coil is a conducting wire made of a carbon nanotube material.

14. The photovoltaic road system according to claim 9, wherein the photovoltaic road system further comprises a detection system and a control system, the detection system is used to detect power levels of vehicle-mounted batteries of different target vehicles and transfer a detection result to the control system, and the control system adjusts a current on the transmission coil according to the detection result.
